(19) United States
(12) Patent Application Publication
(10) Pub. No.: US 2023/0045413 A1
(43) Pub. Date: Feb. 9, 2023

(54) Sensor apparatus for detecting the temperature on a flat component, particularly on a motor vehicle window

(71) Applicant: HELLA GmbH & Co. KGaA, Lippstadt (DE)

(72) Inventors: Thomas Niemann, Delmenhorst (DE); Eduard Desch, Hude-Wüsting (DE); Jürgen Palloks, Westerstede (DE); Thomas Horn, Delmenhorst (DE); Olaf Decressin, Lippstadt (DE)

(21) Appl. No.: 17/880,434

(22) Filed: Aug. 3, 2022

(30) Foreign Application Priority Data
Aug. 3, 2021 (DE) 102021120159.4

(51) Int. Cl. G01K 1/14; G01K 1/08

(52) U.S. Cl. CPC G01K 1/14; G01K 1/08

(57) ABSTRACT

In a sensor apparatus for detecting the temperature on a flat component, particularly on a window of a motor vehicle, having at least one sensor housing, having at least one circuit carrier, at least a section of which is arranged inside the sensor housing, and having at least one temperature sensor arranged on the circuit carrier, it is provided as essential to the invention that the circuit carrier includes at least one section embodied as a contact finger, that the temperature sensor is arrange on the contact finger, that the contact finger has a contact region for thermal coupling with the flat component, that the contact region is connected in thermally conductive manner to the temperature sensor, that the sensor housing has at least one deflection element impinging on the contact finger with a bias.

The invention relates to a sensor apparatus for detecting the temperature on a flat component, particularly on a window of a vehicle, having at least one circuit carrier, at least a portion of which is arranged inside the sensor housing, and having at least one temperature sensor arranged on the circuit carrier.

Particularly in automobile technology, detection of the inside temperature of a window, for example the windscreen is a very important safety consideration. For example, the inside temperature of the windscreen in conjunction with other parameters such as the measured humidity of the vehicle interior and the interior temperature can be used to determine the dewpoint and calculate the likelihood that the windscreen will steam up from the inside.

From DE 10 2018 122 940 A1, for example, a sensor assembly is known for measuring the temperature of a window, in which a rigid pin is brought into thermal contact with the window. Accordingly, an extra component is needed in order to establish a thermal contact with the inside of the window.

The problem addressed by the invention is to suggest a sensor apparatus for determining the inside temperature of a window, which makes it possible to dispense with the need to establish thermal contact with the window.

This problem is solved with a sensor apparatus having the features of claim 1 and with a motor vehicle equipped with a sensor apparatus of the invention according to claim 12. Further developments and advantageous variants are described in the subordinate claims.

In a sensor apparatus for detecting the temperature on a flat component, particularly on a window of a vehicle, having at least one sensor housing, having at least one arranged circuit carrier at least a portion of which is arranged inside the sensor housing, and having at least one temperature sensor arranged on the circuit carrier, it is provided as essential to the invention that the circuit carrier has at least one section embodied as a contact finger, that the temperature sensor is arranged on the contact finger, that the contact finger has a contact region for thermal coupling with the flat component, that the contact region is connected to the temperature sensor in thermally conductive manner, that the sensor housing has at least one deflection element for exerting a preload on the contact finger.

The sensor apparatus has a sensor housing which is provided for arrangement on the flat component that is to be monitored, for example on the window, particularly a windscreen of a vehicle. To this end, the housing may have a contact surface which is brought to bear on the window. In particular, the housing may be positioned on the inside of the windscreen. A circuit carrier is arranged inside the housing, on which at least one temperature sensor is arranged for detecting the inside temperature of the window, and further electronic components, for example evaluation electronics for evaluating the measurement data from the temperature sensor and the like. The circuit carrier may particularly be a printed circuit board or PC board, consisting of electrically insulating material with electrically conductive connections, that is to say the conducting paths, bonded thereto. Fibre-reinforced plastic may be used as insulating material, for example. In particular, the printed circuit board may be of multilayer construction. The conducting paths may consist of thin copper layers. Thus, the circuit carrier may be a commercially available standard component. The circuit carrier forms at least one contact finger, wherein the contact finger is formed by a section of the circuit carrier. The temperature sensor for detecting the inside temperature of the window is arranged on said contact finger. To ensure thermal coupling with the surface that is to be monitored, the contact finger has a contact region which is brought to bear on the surface to be monitored. The contact region may be formed for example by a metallic region, wherein the high thermal conductivity of the metal ensures good thermal coupling with the window. The contact region is connected to the temperature sensor in thermally conductive manner. The thermal connection between the temperature sensor and the contact region may be established via a metallic conducting path, for example. The temperature sensor is preferably arranged in spatial proximity to the contact region, in order to minimise thermal losses during transmission to the temperature sensor. In this way, the temperature sensor on the contact finger of the circuit carriers may be connected simply with other evaluation electronics. The sensor housing includes at least one deflection element, with which the contact finger is mechanically preloaded. In particular, in this arrangement the contact finger is pivoted out of the plane that is spanned by the circuit carrier in the unloaded state. This deflection out of the plane endows the contact finger with a mechanical pretension. Now, when the sensor housing is placed on the intended window, the contact region is pressed against the window with the result that a good thermal contact is created. The contact finger is substantially elongated in form and has one free end and one end connected to the circuit carrier. The contact surface for creating the thermal coupling is located on the free end, which undergoes maximum deflection out of the plane of the printed circuit board. The formation of the contact finger by the circuit carrier provides a simple way to create a thermal coupling with the window to be monitored, without the need to provide any extra components for this purpose.

In one embodiment of the invention, the circuit carrier is constructed as a single part, the circuit carrier has at least one cutout, and the circuit carrier is divided by the cutout into a main section and the contact finger. The flat circuit carrier, which is in particular embodied as a printed circuit board, has a cutout in the form of a gap, which splits the circuit carrier into a contact finger and a main section with a larger surface area. Because of the cutout, the contact finger has one free end and one end which is permanently connected to the circuit. Thus, the contact finger has a certain flexibility with respect to the main section, thereby enabling the contact finger to be deflected out of the plane spanned notionally by the main section in the direction of the surface to be monitored to apply a pretension.

In one embodiment of the invention, the cutout imparts an elastically flexible quality to the contact finger with respect to the main section. Due to the gap-like cutout between the contact finger and the main section, the contact finger may only be connected to the main section of the circuit carrier via a narrow web. In this way, even with the circuit carrier material which is relatively rigid in and of itself, the contact finger is endowed with an elastic flexibility compared with the main section. Thus a simple means is created whereby a load can be applied to the contact finger with a mechanical bias, so with a pretension, by deflection out of the plane spanned by the main section.

In one embodiment of the invention, the cutout is substantially elongated in form, and a portion of the cutout is arranged substantially parallel to one side of the circuit carrier. In particular, the circuit carrier may be substantially rectangular. The gap-like cutout in the circuit carrier may be aligned substantially parallel to an outer edge of the circuit carrier and may extend over most of the length of the edge. In particular, the cutout may be created in the circuit carrier in such manner that a narrow contact finger is formed, which is connected to the main section of the circuit carrier via a narrow web. At the same time, the main section of the circuit carrier is considerably larger in terms of area than the contact finger.

In one embodiment of the invention, in the pretensioned state the contact finger is pivoted out of the plane spanned by the main section of the circuit carrier. In the not pretensioned state, the contact finger and the main section of the circuit carrier both span a notional plane. The contact finger may be pivoted out of this spanned plane to create a mechanical bias, so to create a pretension, by the effect of the deflection element.

In one embodiment of the invention, the sensor housing has at least one cutout on the sensor housing wall thereof which is provided to enable it to be positioned on the flat component, and in the biased state at least a portion of the contact finger protrudes through the cutout. The sensor housing includes a housing wall, which is provided to enable contact with the component that is to be monitored, in particular with the window to be monitored. A cutout is created in this housing wall, and the contact finger may be pivoted to protrude through it. In particular, the contact region of the contact fingers is pivoted to protrude through the cutout, so that a thermal contact may be created with the window to be monitored.

In a further development of the invention, the sensor housing consists of at least two housing parts, and the cutout and the deflection element are arranged on different housing parts. In particular, the sensor housing may have a base part and a cover part, wherein the base part may be provided to enable contact with the windscreen. Thus, the base part may include the cutout through which the contact finger protrudes when it pivots. The base part and the cover part may each have a flat base area, which may be arranged substantially parallel to each other. For example, the circuit carrier may be arranged on the base part, wherein the circuit carrier and the base area of the base part may be arranged substantially parallel to each other. For example, the base part may further have walls which extend around the sides of the base area. The deflection element may be arranged in particular on the inner side of the base area of the cover part, that is to say on the side of the cover part's base area which faces the base part. The deflection element may then be for example a pin-like protrusion or the like. In particular, the deflection element may be arranged perpendicularly to the base area of the cover part. The deflection element may then by dimensioned such that when the two housing parts are joined the contact finger is pressed out of the plane spanned by the main section of the circuit carrier. The arrangement of the deflection element on the cover part provides a simple way to enable a pretension to be exerted on the contact finger when the sensor housing parts are brought together.

In a further development of the invention, the two housing parts are connected to each other by means of at least one latch connection, and when a latch connection is created between the housing parts the contact finger is pivoted out of the plane spanned by the circuit carrier in the unloaded state by the deflection element. The two housing parts, that is to say the cover part and the base part, are connected to each other by means of at least one latch connection, wherein for example the base part has a detent lug, which engages in a detent plate, so a latching tab, on the cover part. The deflection element of the cover part is dimensioned such that when a detent connection has been fully established, that is to say when the detent lug on the base part engages in the detent plate on the cover part, the deflection element presses on the contact finger and thus pivots it out of the plane spanned by the circuit carrier in the unloaded state. The notional planes spanned by the contact finger and the main section of the circuit carrier thus intersect one another. This arrangement and dimensioning of the detent connection and deflection element serves as a simple way to impinge on the contact finger with a bias when the sensor housing is joined together.

In on embodiment of the invention, the circuit carrier is a printed circuit board. In particular, the circuit carrier may be a multilayer printed circuit board made from insulating material, for example fibre-reinforced plastic and metallic layers, for example copper. When a standardised printed circuit board is used and a cutout is created correspondingly to produce the contact finger, the result is a particularly inexpensive means for creating an element for thermal coupling of the sensor.

In a further development of the invention, the contact region is located on the free end of the contact finger. The contact finger has one end which is connected to the main section of the circuit carrier via a web, and a free end which can undergo maximum deflection. The contact region for creating a thermal coupling with the window to be monitored is located on the free end of the contact finger to achieve the greatest possible pressing force and therewith the best possible thermal coupling with the window.

In one embodiment of the invention, the contact region is formed by a metal surface of the printed circuit board. A metal surface of the printed circuit board, which is in particular of multilayer construction, may serve as a contact region. For this purpose, for example a metal surface which is covered by an insulating layer may be exposed, particularly exposed by etching, to expose the metallic contact region. The use of a metal surface of the printed circuit board enables the capability of forming a thermal contact region very simply and inexpensively.

The invention further relates to a vehicle with a sensor apparatus according to the invention for detecting the temperature on a window, particularly on the windscreen, wherein one wall of the sensor housing is arranged substantially parallel to the window that is to be monitored, and wherein the contact region of the contact fingers has a thermally conductive contact with the window. The contact finger is subjected to a mechanical bias, so a mechanical pretension, by a deflection of the contact finger out of the plane spanned by the circuit carrier in the unloaded state by means of a deflection element. This in turn produces a thermal contact between the contact finger and the window to be monitored. Since the contact finger is formed by the circuit carrier, the sensor apparatus may be constructed in a particularly cost-efficient manner.

In a further development of the invention, the sensor housing is connected to the window via at least one connecting means, and the contact region of the contact finger is pressed against the window due to the connection between the window and the sensor housing. In a state of deflection by the deflection element, the contact finger of the circuit carrier protrudes from the sensor housing. Connecting means such as clamp connections, detent connections, so latch connections, or the like may be provided on the window, and used to attach the sensor housing to the window. In this context, the connection between the window and the sensor housing is dimensioned such that the sensor housing with the protruding contact finger is pressed against the window to produce a thermal contact between contact finger and window. In this way, when the sensor housing is mounted on the window the thermal contact is created automatically.

In one embodiment of the invention, the main section of the circuit carrier is arranged substantially parallel to the window, and the contact finger extends at an angle to the plane spanned by the main section. Inside the housing, the circuit carrier is arranged substantially parallel to the window. The contact finger is deflected out of the notional plane spanned by the main section of the circuit carrier via the deflection element in the sensor housing, with the result that the contact finger is inclined towards the window. Consequently, when the sensor housing is assembled a pressing forces acts on the contact finger, thereby producing a reliable thermal contact between the temperature sensor and the window.

In the following text, the invention will be explained in greater detail with reference to an embodiment illustrated in the drawing. Individually, the schematic illustrations show:

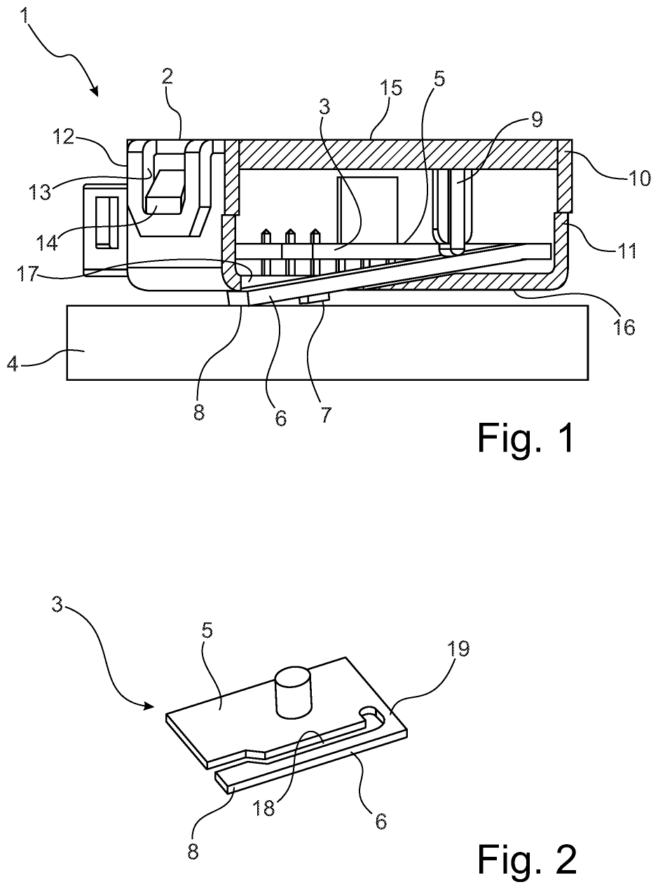

FIG. 1: a partial cutaway view of a sensor apparatus with a sensor housing on a window; and

FIG. 2: a circuit carrier in the unloaded state.

FIG. 1 shows a partial cutaway view of a sensor apparatus 1 with a sensor housing 2 and a circuit carrier 3. The sensor housing 2 is arranged on a window 4. The circuit carrier 3 has a main section 5 and a contact finger 6. In particular, the main section 5 and the contact finger 6 are made from a single-part circuit carrier 3. A temperature sensor 7 is arranged on the contact finger 6 for detecting the temperature on the inside of window 4. To this end, the temperature sensor 7 is connected to a coupling region 8 of the contact finger 6 in thermally conductive manner. The contact region 8 may be formed for example by a metal surface, for example conductive layer of the for example multilayer circuit carrier 3. The contact region 8 is pressed against the window 4 for the purpose of thermal coupling. To this end, the contact finger 6 is pivoted out of the notional plane spanned by the main section 5 by means of a deflection element 9. The deflection element 9 thus imparts a mechanical pretension to the contact finger 6, by which the contact region 8 may be pressed against the window when the sensor housing 2 is brought into contact with the window 4. The sensor housing 2 is constructed in two parts, wherein the sensor housing 2 includes a cover part 10 and a base part 11. The cover part 10 and the base part 11 are connected to one another via at least one detent connection 12, so a latch connection. In order to create the detent connection, the cover part 10 has a detent plate 13, the base part 11 has a corresponding detent lug 14. The deflection element is embodied as a protrusion and is aligned substantially perpendicularly to the base area 15 of the cover part 10. The deflection element 9 is dimensioned such that when a detent connection 12 is fully in place, that is to say when the detent lug 14 is fully engaged in the detent plate 13, the deflection element 9 presses on the contact finger 6 of the circuit carrier 3 and pivots it out of the notional plane spanned by the main section 5. The base area 16 of the base part 11 has a cutout 17, and the contact finger 6 may be pivoted to protrude through said cutout. The contact region 8 of the contact finger 6 thus protrudes from the sensor housing 2, so that the contact region 8 can be brought into thermal contact with the window 4.

In FIG. 2, the circuit carrier 3 with the main section 5 and the contact finger 6 is illustrated on its own in perspective view. The main section 5 and the contact finger 6 are formed by a cutout 18 created in the circuit carrier 3. Consequently, the main section 5 has a substantially larger surface area than the contact finger 6. The contact finger 6 is connected to the main section 5 via a web-like connection 19. Due to the relatively low material thickness of the web-like connection 19, the contact finger 6 has a certain flexibility with respect to the main section 5. In the unloaded state, the main section 5 and the contact finger 6 are aligned in one notional plane. In the deflected state, that is to say in a state in which the deflection element acts on it, the contact finger 6 is pivoted out of the notional plane spanned by the main section 5 to produce a mechanical bias.

All of the features described in the preceding description and in the claims may be combined in any permutation with the features of the independent claim. The disclosure of the invention is thus not limited to the feature combinations described and/or claimed, but rather all meaningful feature combinations within the scope of the invention are to be considered disclosed.

1. Sensor apparatus for detecting the temperature on a flat component, particularly on a window of a vehicle, having at least one sensor housing, having at least one circuit carrier, at least a section of which is arranged inside the sensor housing, and having at least one temperature sensor arranged on the circuit carrier, wherein
the circuit carrier has at least one section embodied as a contact finger,
the temperature sensor is arranged on the contact finger,
the contact finger includes a contact region for thermal coupling with the flat component,
the contact region is connected in thermally conductive manner to the temperature sensor, and
the sensor housing includes at least one deflection element impinging on the contact finger with a pretensioning.

2. Sensor apparatus according to claim 1, wherein the circuit carrier is constructed as a single part, that the circuit carrier has at least one cutout, and that due to the cutout the circuit carrier is divided into a main section and the contact finger.

3. Sensor apparatus according to claim 2, wherein the contact finger is elastically flexible with respect to the main section as a result of the cutout.

4. Sensor apparatus according to claim 2, wherein the cutout is substantially elongated, and that at least a part of the cutout is aligned substantially parallel to a side of the circuit carrier.

5. Sensor apparatus according to claim 1 , wherein in the pretensioned state the contact finger is pivoted out of the plane spanned by the main section of the circuit carrier.

6. Sensor apparatus according to claim 1, wherein the sensor housing has at least one cutout on the sensor housing wall provided for arrangement on the flat component, and that in the pretensioned state at least a portion of the contact finger protrudes through the cutout.

7. Sensor apparatus according to claim 1, wherein the sensor housing consists of at least two housing parts, and that the cutout and the deflection element are arranged on different housing parts.

8. Sensor apparatus according to claim 7, wherein the two sensor housing parts are connected to one another via at least one latch connection, and that when the latch connection is established between the sensor housing parts the contact finger is pivoted by the deflection element out of the plane that is spanned by the circuit carrier in the unloaded state.

9. Sensor apparatus according to claim 1, wherein the circuit carrier is a printed circuit board.

10. Sensor apparatus according to claim 1, wherein the contact region is arranged on the free end of the contact finger.

11. Sensor apparatus according to claim 1, wherein the contact region is formed by a metal surface of the circuit carrier

12. Vehicle with a sensor apparatus for detecting the temperature on a window, particularly on the windscreen, according to claim 1, wherein a wall of the sensor housing is arranged substantially parallel to the window that is to be monitored, wherein the contact region of the contact finger has a thermally conductive contact with the window.

13. Vehicle according to claim 12, wherein the sensor housing is connected to the window via at least one connection means, and that the contact region of the contact finger is pressed against the window due to the connection between the window and the sensor housing.

14. Vehicle according to claim 12, wherein the main section of the circuit carriers is arranged substantially parallel to the window, and that the contact finger extends at an angle to the plane spanned by the main section.
